(19) United States
(12) Patent Application Publication
(10) Pub. No.: US 2005/0017203 A1
(43) Pub. Date: Jan. 27, 2005

(54) Infrared emitter embodied as a planar emitter

(76) Inventor: Richard Aust, Monchengladbach (DE)

Correspondence Address: Todd T. Taylor;Taylor & Aust PC, 142 S. Main St. PO Box 560, Avilla, IN, 46710, US

(21) Appl. No.: 10/917,185

(22) Filed: Aug. 11, 2004

Related U.S. Application Data
(63) Continuation of application No. PCT/DE03/00387, filed on Feb. 11, 2003.

(30) Foreign Application Priority Data
Feb. 12, 2002 (DE) 102 05 922.5
May 22, 2002 (DE) 102 22 450.1

(51) Int. Cl. G01J 5/02

(52) U.S. Cl. 250/493.1

(57) ABSTRACT

A radiant element which is heated on its rear side by a burning fluid-air mixture and whose front side emits the infrared radiation. The radiant element is produced from a highly heat resistant material which contains more than 50% by weight of a metal silicide, preferably molybdenum disilicide (MoSi₂) or tungsten disilicide (WSi₂).

The invention relates to an infrared emitter embodied as a planar emitter, comprising a radiant element which is heated on its rear side by a burning fluid-air mixture and whose front side emits the infrared radiation.

As is known, infrared emitters embodied as planar emitters are used in dryer systems which are used to dry web materials, for example paper or board webs. Depending on the width of the web to be dried and the desired heating output, the requisite number of emitters is assembled with aligned emission surfaces to form a drying unit.

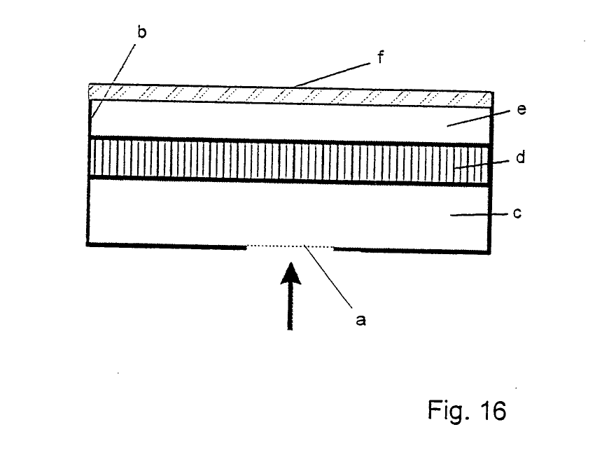

The basic structure of a single generic infrared emitter is illustrated in FIG. 16 and described, for example, in DE 199 01 145-A1.

The fuel/air mixture needed for the operation of the emitter is supplied to the emitter through an opening (a) in the housing (b) and firstly passes into a distribution chamber (c), in which the mixture is distributed uniformly over the emitter surface, at right angles to the view shown here. The gases then pass through a barrier (d) which is configured so as to be permeable. The main task of the barrier (d) is to isolate the combustion chamber (e), in which the gas is burned, from the distribution chamber (c), in which the unburned gas mixture is located, in such a way that no flashback from the combustion chamber (e) to the distribution chamber (c) can take place. In addition, the barrier (d) should expediently be designed such that the best possible heat transfer from the hot combustion waste gases to the solid element that emits the radiation, that is to say the surface of the barrier (d) itself or possibly the walls of the combustion chamber (e) and the actual radiant element (f) is prepared. The geometric/constructional configuration of combustion chamber (e) and radiant element (f) is likewise carried out from the following points of view:
optimized heat transfer,
maximized heat emission,
minimum heat losses to the side and in the direction of the distribution chamber,
   taking into account thermal expansion which occurs and application-specific special features, such as possible contamination, thermal shock which occurs, and so on.

The invention is based on the object of maximizing the lifetime of such a construction by using a particularly suitable material for the radiant element, since the latter as a rule represents the wearing part of the construction.

According to the invention, this object is achieved by the radiant element being produced from a highly heat-resistant material which contains more than 50% by weight of a metal silicide, preferably molybdenum disilicide (MoSi₂) or tungsten disilicide (WSi₂).

An infrared emitter according to the invention may be operated for a very high specific heat output with flame temperatures of more than 1200° C., if necessary even more than 1700° C. In this case, the radiant element has a high emission factor and a long service life. Added to this is the further advantage that the material can be provided in various forms in order to optimize the emission behavior and the convective heat transfer.

The subclaims contain refinements of an infrared emitter according to the invention which are preferred, since they are particularly advantageous.

The drawing is used to explain the invention by using exemplary embodiments illustrated in simplified form. In the drawing:

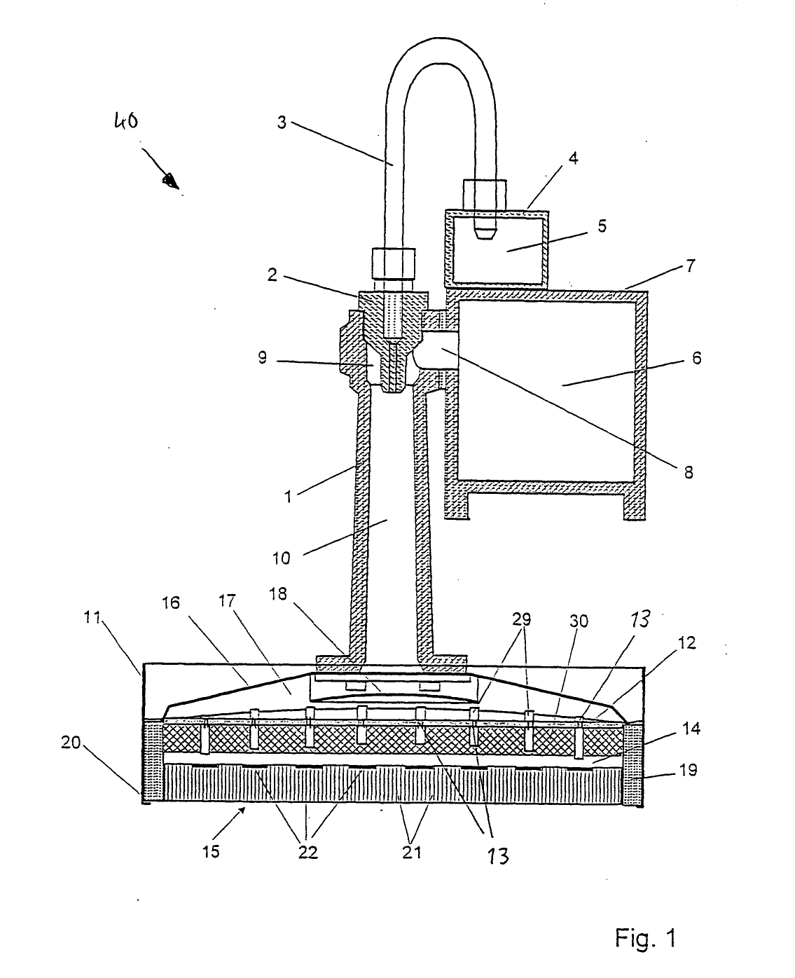

FIG. 1 shows a cross section through the structure of an infrared emitter according to the invention,

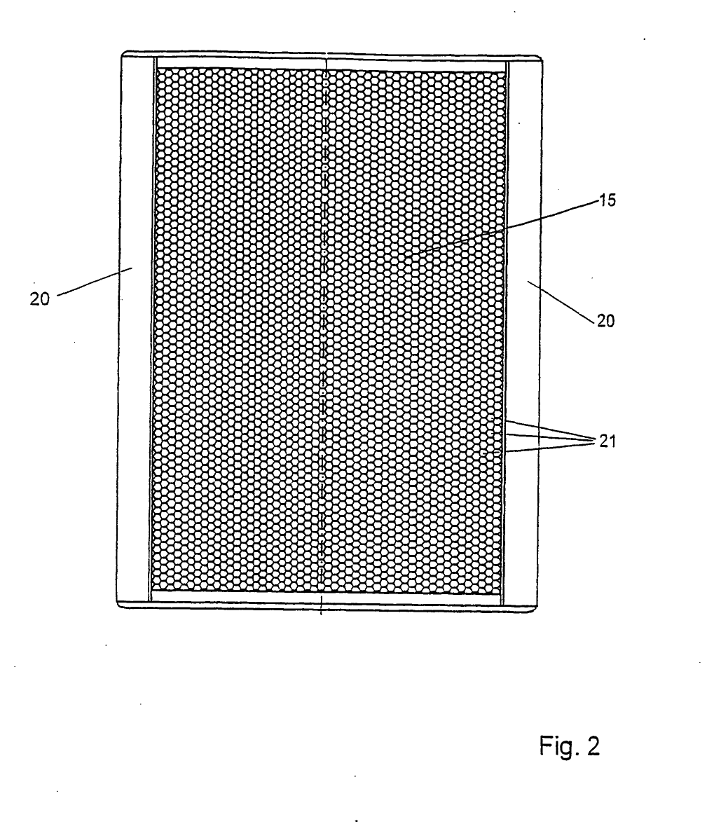

FIG. 2 shows a plan view of the emitting front side of the radiant element according to FIG. 1,

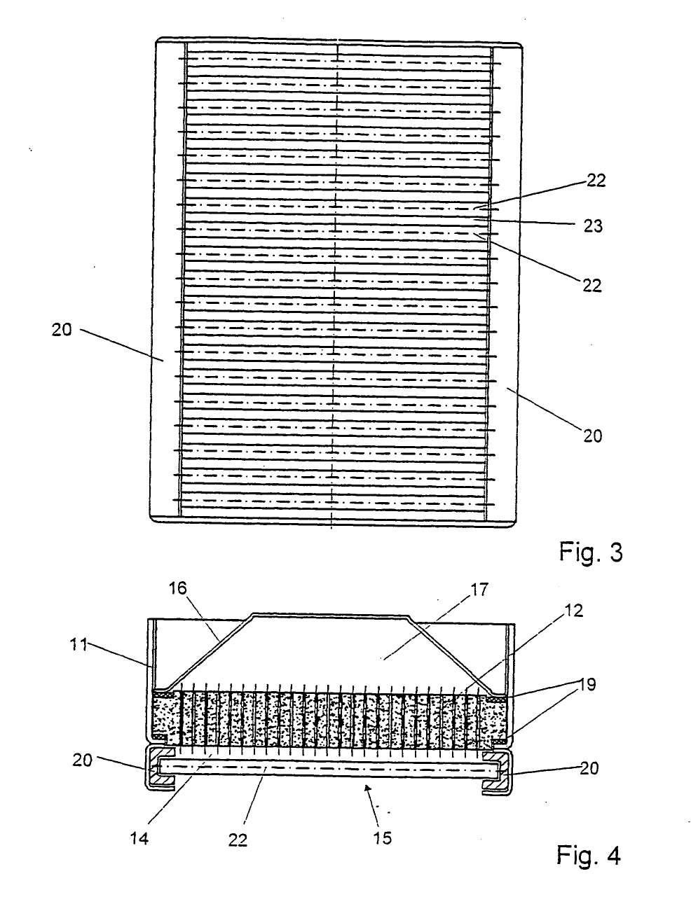

FIG. 3 shows a plan review of a radiant element which is built up from individual tubes,

FIG. 4 shows as an extract a section through the emitter having the radiant element according to FIG. 3,

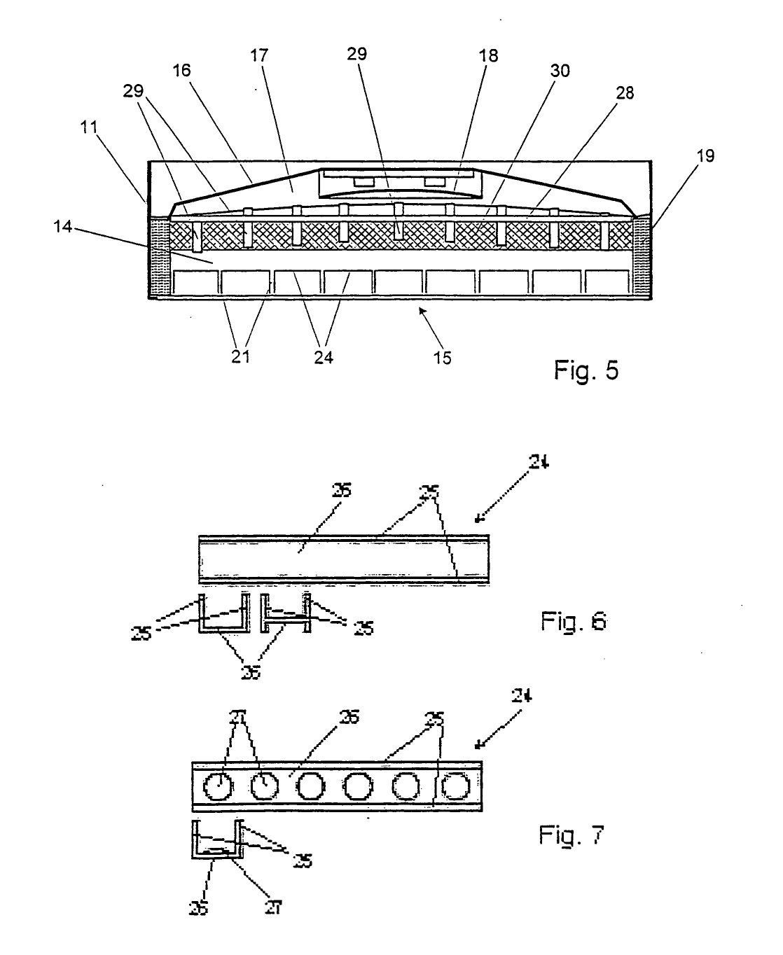

FIG. 5 shows a section through the housing of an emitter whose radiant element is built up from individual strips,

FIG. 6 to FIG. 12 in each case show the plan view and/or cross sections through variously configured and arranged strips,

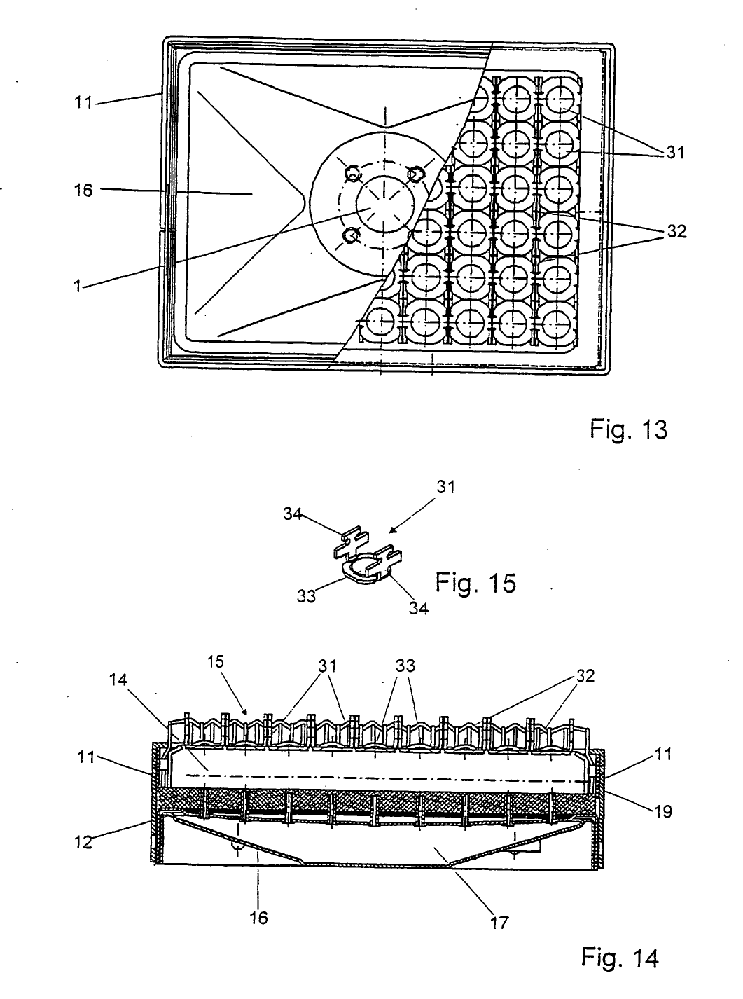

FIG. 13 shows a further embodiment from the rear side of the emitter housing, the hood of the emitter being shown partly opened,

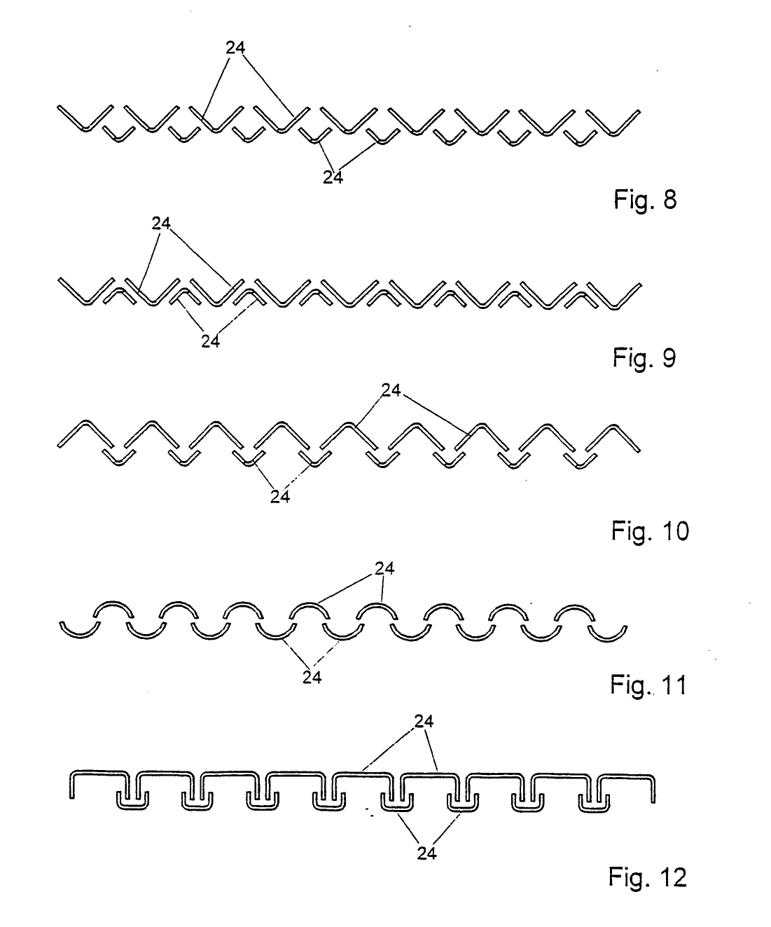

FIG. 14 shows a section through the emitter housing of the embodiment according to FIG. 8,

FIG. 15 shows an individual radiating element of the radiant element,

FIG. 16 shows the basic structure of an emitter housing in cross section.

The infrared emitters according to the invention are preferably heated with gas; alternatively, heating with a liquid fuel as a heating fluid is possible.

As FIG. 1 illustrates, each emitter contains a mixing pipe 1, into which a mixing jet 2 is screwed at one end. Connected to the mixing jet 2 is a gas supply line 3, which is connected to a manifold line 4, from which a plurality of emitters arranged beside one another are supplied with gas 5. The supply with air 6 is provided via a hollow crossmember 7, to which the mixing pipe 1 is fixed. The connecting line 8 for the air supply opens in the upper part of the mixing pipe 1 into an air chamber 9 which is open at the bottom and surrounds the outlet end of the mixing jet 2, so that a gas-air mixture is introduced into the mixing chamber 10 of the mixing pipe 1 from above.

Fixed at the lower, open end of the mixing pipe 1 is a housing 11, in which a ceramic burner plate 12 is arranged as a barrier. The burner plate 12 contains a series of continuous holes 13, which open into a combustion chamber 14, which is formed between the burner plate 12 and a radiant element 15 arranged substantially parallel to and at a distance from the latter. In the combustion chamber 14, flames are formed, which heat the radiant element 15 from the rear, so that the latter emits infrared radiation.

For the supply of the gas-air mixture, the mixing pipe 1 opens into a distribution chamber 17, which is sealed off by a hood 16 and is connected to the other end of the burner plate 12. In order that the gas-air mixture is distributed uniformly on the rear of the burner plate 12, a baffle plate 18, against which the mixture supplied flows, is arranged in the distribution chamber 17. The burner plate 12 is fitted in the housing 11 in peripheral, fireproof seals 19. The radiant element 15 hangs in a peripheral fireproof frame 20, which is fixed to the housing 11 and, together with the seals 19, terminates the combustion chamber 14 in a gastight manner at the sides.

The radiant element 15 is fabricated from a highly heat-resistant material which contains more than 50% by weight of a metal silicide as its main constituent. The metal silicides used are preferably molybdenum disilicide (MoSi₂) or tungsten disilicide (WSi₂). Silicon oxide (SiO₂), zirconium oxide (ZrO₂) or silicon carbide (SiC) or mixtures of these compounds are preferably contained as further constituents. These materials are extremely temperature-resistant and stable, so that the emitter—if necessary—can be operated with flame temperatures of more than 1700° C. up to 1850° C. As compared with a likewise high-temperature-resistant alloy which consists exclusively of metals (for example a metallic heat conductor alloy), the material has the further advantage that no scaling occurs. In order to obtain an extremely long service life of the emitter, this can be operated with a flame temperature somewhat below the maximum possible temperature of the radiant element 15; for example between 1100° C. and 1400° C., by which means the formation of thermal NOₓ is kept within tolerable bounds.

In the embodiment according to FIGS. 1 and 2, the radiant element 15 consists of a block which contains a large number of continuous ducts 21. The ducts 21 are heated on the rear side of the radiant element 15 bounding the combustion chamber 14. The ducts 21 are either tubular or slot-like. The cross section of the tubular ducts is preferably either circular or in the form of a regular polygon. In the embodiment according to FIG. 2, the ducts 21 are arranged beside one another in the form of a honeycomb. Alternatively, the ducts 21 can also be formed in the manner of slots. For this purpose, the radiant element 15 is preferably built up from a row of plates arranged at a distance from one another, whose interspaces form the slot-like ducts.

FIGS. 3 and 4 illustrate an embodiment in which the radiant element 15 is built up from a plurality of tubes 22 or rods arranged at a distance from one another. The tubes 22 or rods extend parallel to the burner plate 14 and are fixed with their ends in each case in the frame 20. The outer side of the tubes 22 form the emitting front surface; in each case between two tubes 22 a gap-like opening 23 is formed, through which hot combustion waste gases and also infrared radiation can emerge.

A particularly advantageous embodiment of an emitter is illustrated in FIG. 5. In this embodiment, the radiant element 15 is built up from a plurality of strips 24 arranged at a distance from one another which, like the tubes 22 in FIG. 4, are arranged parallel to the barrier and at their ends are mounted in the frame of the housing 11. In all the embodiments described in the following text, the strips are constructed and arranged in such a way that parts thereof form baffle surfaces for the flames.

In the exemplary embodiment illustrated in FIGS. 6 and 7, the strips 24 have a U-shaped or H-shaped cross section, the open sides being oriented outward between the two legs 25 (downward in FIG. 5). The transverse webs 26 between the legs 25 bound the combustion chamber 14 and form the baffle surfaces for the flames. When used with the construction of the barrier described in the following text, the baffle surface effects the maximum convective heat transfer from the flames to the radiant element 15. For this purpose, the transverse webs 26 of the strips 24 have indentations 27 which are preferably oriented counter to the flames, as illustrated in FIG. 7. The indentations 27 act as enlarged baffle surfaces intercepting the flames. Between two strips 24 in each case there are arranged slot-like openings 23, which permit the combustion waste gases to be led away. Each strip 24 is fabricated from the highly heat-resistant material described above, which contains more than 50% by weight of MoSi₂ or WSi₂ as its main constituent.

In FIGS. 8 to 12, preferred embodiments are illustrated in cross section, in which the radiant element is built up from at least two layers of strips 24 located above one another. In operation, the strips 24 of the two layers assume different emission temperatures, which increases the efficiency considerably. In FIGS. 8 to 12, the flames are oriented from top to bottom, just as in FIGS. 1 to 5.

In the radiant elements according to FIGS. 8 to 10, the strips 24 are in each case configured as angled profiles having two legs. The two legs form an angle of between 30° and 150° with respect to each other, preferably around 90°. The strips 24 of the two layers are arranged offset from one another, so that the combustion waste gases are additionally deflected as they pass through the two layers. The deflection effects a considerably improved heat transfer to the two layers. In the embodiment according to FIG. 8, the angled profiled strips of the two layers are oriented in the same direction in the flame direction and arranged offset from one another; in the embodiment according to FIG. 9, they are oriented in opposite directions to one another. In both embodiments, the flames impinge in the angle of the strips 24 of the upper layer. In the arrangement according to FIG. 10, the strips are likewise arranged in opposite directions and offset from one another, the flames impinging on the angled side of the strips of the lower layer.

FIG. 11 illustrates an embodiment in which the radiant element 15 is built up from strips 24 which are each configured in the form of a half shell. The half-shell strips 24 are in each case aligned in opposite directions in the two layers and are arranged offset from one another, so that the combustion waste gases are very largely deflected in this embodiment too.

In FIG. 12, the strips 24, as in the embodiment according to FIG. 5, have a U-shaped cross section. They are likewise arranged in two layers, the strips 24 of the lower layer in each case being arranged in opposite directions and offset from the strips 24 of the upper layer. In this way, the strips 24 of the lower layer cover the interspace between two strips 24 of the upper layer and thus force the combustion waste gases emerging through the interspaces to make a direction change through 180°.

In FIG. 5, a particularly advantageous embodiment of the barrier is illustrated, which can also be used in conjunction with the radiant elements 15 illustrated in other figures instead of the ceramic burner plate 12. The barrier comprises a jet plate 28 made of a heat-resistant metal, into which a row of tubular jets 29, which are likewise fabricated from metal, are inserted. The gas-air mixture emerges from the distribution chamber 17 into the combustion chamber 14 through the jets 29. In this case, the jets 29 are arranged in such a way that the outlet opening of each jet 29 is aimed toward baffle surfaces formed by parts of the radiant element 15. In the exemplary embodiment according to FIG. 5, the outlet openings of the jets 29 are in each case aimed approximately centrally toward the transverse web 26 of a strip 24 of the radiant element 15. In the embodiment according to FIG. 7, each jet 29 is aimed toward an indentation 27 in the transverse web 26. On the side of the combustion chamber 14, the jets 29 are embedded in a gas-permeable fibrous nonwoven 30 made of a heat-resistant material. The fibrous nonwoven 30, made of highly temperature-resistant ceramic fibers, acts as an insulating layer for the jet plate 28 and in this way prevents the latter being damaged by the high temperatures in the combustion chamber 14. The diameter of a jet 29 is 1.5 mm-4 mm. As compared with the ceramic burner plate 12 shown in FIG. 1, the jet plate 28 contains comparatively few passage openings for the gas-air mixture. There are about 1500-2500 openings (jets 29) per m² of the area of the jet plate 28.

FIGS. 13 to 16 illustrate a further embodiment of an infrared emitter according to the invention, in which the radiant element is built up from a large number of radiating elements 31 arranged beside one another. FIG. 13 illustrates a view of the rear side of the emitter housing 11, the hood 16 and the burner plate 12 being partly not shown, in order to permit a view of the radiant element from inside.

In this embodiment, the emitter housing 11 is sealed off, on its front side emitting the infrared radiation, by a metal grid 32 made of a heat-resistant metal, into which a large number of radiating elements 31 are hooked.

Each radiating element 31 is fabricated from the highly heat-resistant material described above, which contains more than 50% by weight of MoSi₂ as its main constituent. It comprises an approximately square panel 33 with lateral hooks 34, with which it can be hooked into the grid 32. The radiating elements 21 are hooked into the grid 32 in such a way that the panels 33 form an impingement surface for the flames which is parallel to the burner plate 12 and which is interrupted only by passage openings between the individual panels 33. The inner region of each panel 33 is preferably curved outward somewhat, in order that the impingement surface of the flames is enlarged.

Because of their possible use at very high temperatures of more than 1100° C., their high specific power density and their long service life, the infrared emitters according to the invention are particularly suitable for drying web materials at high web speeds. One preferred area of application is the drying of moving board or paper webs in paper mills, for example downstream of coating apparatus.

1. An infrared emitter embodied as a planar emitter, comprising a radiant element (15) which is heated on its rear side by a burning fluid-air mixture and whose front side emits the infrared radiation, characterized in that the radiant element (15) is produced from a highly heat-resistant material which contains more than 50% by weight of a metal silicide.

2. The infrared emitter as claimed in claim 1, characterized in that the material contains more than 50% by weight of molybdenum disilicide (MoSi₂).

3. The infrared emitter as claimed in claim 1, characterized in that the material contains more than 50% by weight of tungsten disilicide (WSi₂).

4. The infrared emitter as claimed in one of claims 1 to 3, characterized in that the material of the radiant element (15) contains silicon oxide (SiO₂) as a further constituent.

5. The infrared emitter as claimed in one of claims 1 to 3, characterized in that the material of the radiant element (15) contains zirconium oxide (ZrO₂) as a further constituent.

6. The infrared emitter as claimed in one of claims 1 to 3, characterized in that the material of the radiant element (15) contains silicon carbide (SiC) as a further constituent.

7. The infrared emitter as claimed in one of claims 1 to 6, characterized in that the radiant element (15) consists of a block which contains a large number of continuous ducts (21).

8. The infrared emitter as claimed in one of claims 1 to 6, characterized in that the radiant element (15) is built up from a row of plates arranged at a distance from one another.

9. The infrared emitter as claimed in one of claims 1 to 6, characterized in that the radiant element (15) is built up from a plurality of tubes (22) or rods arranged at a distance from one another, which are fixed with their ends in each case in a frame (20) on the emitter housing (11).

10. The infrared emitter as claimed in one of claims 1 to 6, characterized in that the radiant element (15) is built up from a plurality of strips (24) arranged at a distance from one another, which have baffle surfaces for the flames.

11. The infrared emitter as claimed in claim 10, characterized in that the strips (24) in each case have a U-shaped or H-shaped cross section with a transverse web (26) forming the baffle surface and legs (25) oriented outward.

12. The infrared emitter as claimed in either of claims 10 and 11, characterized in that the transverse webs (26) of the strips (24) have indentations (27) which are oriented counter to the flames.

13. The infrared emitter as claimed in claim 10, characterized in that the radiant element (15) is built up from angled profiled strips (24) each having two legs.

14. The infrared emitter as claimed in claim 13, characterized in that the two legs of a strip (24) have an angle of between 30° and 150°.

15. The infrared emitter as claimed in claim 10, characterized in that the strips (24) are configured in the form of a half-shell.

16. The infrared emitter as claimed in one of claims 10 to 15, characterized in that the radiant element (15) is built up from at least two layers of strips (24) located above one another, the strips of one layer being arranged offset from the strips of the other layer.

17. The infrared emitter as claimed in one of claims 1 to 6, characterized in that the radiant element (15) is built up from individual radiating elements (31) which are hooked into a grid (32) fixed to the housing (11).

18. The infrared emitter as claimed in claim 17, characterized in that the radiating elements partly have the form of a panel (33) and are hooked into the grid (25) in such a way that they form an impingement surface for the flames which is closed apart from passage openings.

19. The infrared emitter as claimed in one of claims 1 to 18, comprising a gas permeable barrier which bounds the combustion chamber (14), characterized in that the barrier consists of a jet plate (28), into which a row of tubular jets (29) is inserted and which, on the combustion-chamber side, is embedded in a gas-permeable fibrous nonwoven (30) made of ceramic fibers.

20. The infrared emitter as claimed in claim 19, characterized in that the jet plate (28) and the jets (29) are fabricated from a heat-resistant metal.

21. The infrared emitter as claimed in claim 19 or 20, characterized in that the outlet openings of each jet (29) is aimed toward baffle surfaces formed by parts of the radiant element (15).
